(19) United States
(12) Patent Application Publication
(10) Pub. No.: US 2009/0006402 A1
(43) Pub. Date: Jan. 1, 2009

(54) METHODS AND SYSTEMS FOR THE DYNAMIC SELECTION OF A LOCKING STRATEGY

(76) Inventors: Holger Bohle, Dielheim (DE); Marko Degenkolb, Wiesloch (DE); Ralf Halbedel, Heidelberg (DE)

Correspondence Address: SAP / FINNEGAN, HENDERSON LLP, 901 NEW YORK AVENUE, NW, WASHINGTON, DC, 20001-4413, US

(21) Appl. No.: 11/770,090

(22) Filed: Jun. 28, 2007

(51) Int. Cl. G06F 17/30

(52) U.S. Cl. 707/8; 707/9; 707/E17.007

(57) ABSTRACT

Systems and methods are provided for dynamically selecting a locking strategy for a request by a source to use a stored data object in a computerized system. According to one implementation, a method is provided that comprises receiving, by a locking layer, a request from the source to use a stored data object, and determining, with the locking layer, a locking strategy for the request based on a set of locking configuration rules modifiable by a system administrator. The method also includes associating the request with the determined locking strategy. In some implementations, the request and locking strategy may be forwarded to a data management server, which obtains the physical locks on the data objects. The locking strategy may also be changed by the locking layer when the use of the object changes during runtime of the application.

### TECHNICAL FIELD

The present disclosure generally relates to the field of data processing. More specifically, the present disclosure relates to methods, computer program products, and systems for data locking and the selection of a locking strategy.

### BACKGROUND INFORMATION

In computer systems where multiple applications or multiple users have access to the same data, or data objects, locks may be implemented to prevent two transactions from changing the same data simultaneously or to prevent the reading obsolete data. Conceptually, a “lock” is a claim by a user, application, or transaction to a data object that limits access by other users, applications, or transactions. Locks on data objects are typically acquired as soon as possible, often at the start of an application. As used herein, an “application” refers to any computer program or module implemented using hardware logic, firmware, software, or any combination thereof.

Unless otherwise specified, a “data object,” for the purposes of this disclosure, is any data conforming to a particular format. Examples of data objects include an instance of a class of data, one or more records in a database, and/or at least one data value. A data object may also be, for example, an entire web page identified by a URL and/or the resources and data that a web page accesses or portions thereof. A data object may be stored in any media capable of maintaining data for any length of time, such as a CD-ROM, a flash memory device, a magnetic disk, or an optical disk.

Generally, an application requesting access to a data object also requests a lock with a particular “lock mode,” or lock type, as well as other parameters that define the locking strategy. The locking strategy parameters for the request, including the lock mode, is usually hard-coded into the application and cannot easily be overridden or changed. A lock mode is the level of exclusivity, or type of access to the data object that is obtained with a particular lock. Examples of lock modes include “exclusive,” “shared,” and “optimistic.” When an exclusive lock, also known as a write lock or restrictive lock, is obtained by one source, the locked data object can only be displayed or edited by the one source. Typically, when an exclusive lock is obtained, all other requests for locks on that data object are denied. Shared locks, also known as a read locks or collaborative locks, allow multiple sources to display the data object. When a shared lock is obtained, no source is allowed to edit the data object, but any source having the shared lock can read the data object. Optimistic locks are similar to shared locks since they allow multiple users to display the data object, but an optimistic lock can be converted to an exclusive lock by one source.

The locking of data objects by an application or user inherently restricts access to those data objects by other applications and other users, and in some scenarios the restriction causes undesirable results. Locks obtained can be more restrictive than actually necessary for the task to be performed by the requesting application. The dictating of the lock mode by the requesting application may prevent the full utilization of the requesting application and other applications attempting to use the same data objects. An illustrative example is apparent in the development of mash-up applications, which are applications built on top of existing applications combining all or some of the functionality of the existing applications. The mash up application may not work if each of the underlying existing applications demands an exclusive lock on the same data object.

Presently, there is a need for improved methods, software applications, and/or data processing systems that can provide a more efficient solution to one or more of the problems described above. Furthermore, there is a need for a mechanism for locking data objects that is consistent across applications to reduce efforts by developers of applications.

### SUMMARY

Additional objects and advantages will be set forth in part in the description which follows, and in part will be obvious from the description, or may be learned by practice of the embodiments. The objects and advantages will be realized and attained by means of the elements and combinations particularly pointed out in the appended claims.

In one embodiment, a method is provided for dynamically selecting a locking strategy for a request by an application to use a stored data object in a computerized system. The method comprises receiving, by a locking layer, a request from the application to use a stored data object and accessing, with the locking layer, a set of locking configuration rules to determine a locking strategy, which includes a lock mode and may also include a lock scope and lock duration. The locking configuration rules may, in some embodiments, indicate a default locking strategy. The method further comprises determining, with the locking layer, the locking strategy and associating the determined locking strategy with the request.

In accordance with certain embodiments, the locking layer may send the request and associated locking strategy to a data management server, which then obtains a physical lock having the associated locking strategy on the stored data object. Alternatively, the locking layer itself may directly obtain a physical lock having the associated locking strategy on the stored data object.

In accordance with certain embodiments, the locking layer may perform checks for data consistency and for conflicting locks before obtaining a physical lock. Additionally, the locking layer may change the locking strategy for a physical lock that has been obtained when the use of the data object changes. The locking layer typically mediates all requests to use or to change the use of stored data objects according to the methods disclosed herein, and where appropriate, locking strategies for previously acquired locks may be modified. A system administrator may be permitted to modify the locking configuration rules. In addition, users of applications may be allowed to specify aspects of the locking strategy.

As disclosed herein, the functionality of the locking layer may be implemented as an API, which is used by the applications to request the use of stored data objects.

As also disclosed herein, methods consistent with the present invention may be performed during runtime of an application using the stored data objects.

Embodiments of the invention also encompass computer systems, computer programs and computer readable medium, each comprising program code or instructions for selecting a locking strategy. Such computer systems, computer programs and computer readable medium may be implemented according to the inventive methods and features disclosed herein.

In accordance with one embodiment, a computer system is provided for selecting an locking strategy. The computer system comprises a memory comprising program instructions, input means for receiving and entering data, output means for sending and presenting data, storage means for storing data objects, a lock mechanism for locking the data objects, and at least one processor responsive to the program instructions to perform a method for dynamically selecting a locking strategy for a request by an application to a use a stored data object. The method implemented with the processor and program instructions may comprise receiving, by a locking layer, the request from the application to use the stored data object, the locking layer accessing a set of locking configuration rules, determining the locking strategy for the request based on a set of locking configuration rules accessed by the locking layer, and associating the request with the determined locking strategy.

It is to be understood that both the foregoing general description and the following detailed description are exemplary and explanatory only and are not restrictive of embodiments of the invention.

### BRIEF DESCRIPTION OF THE DRAWINGS

The accompanying drawings, which are incorporated in and constitute a part of this specification, illustrate exemplary embodiments of the invention and, together with the description, serve to explain the principles of the invention. In the drawings:

FIG. 1 illustrates an exemplary computer system, consistent with an embodiment of the invention.

FIG. 2 illustrates exemplary sequences of events that may occur in a computer system such as FIG. 1, consistent with an embodiment of the invention;

FIG. 3 is a flow diagram illustrating an exemplary method, consistent with an embodiment of the present invention;

FIG. 4 is a flow diagram illustrating a second exemplary method, consistent with an embodiment of the present invention, where the locking configuration rules include an indication that the source can control part or all of the locking strategy; and

FIG. 5 illustrates an exemplary conventional computer system.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Within the concept of this specification, a “computerized system” broadly refers to any stand alone computer such as a PC, laptop, or series of computers connected via a network, and includes all internal processors, devices, memories, and functions. Additionally, a computerized system includes any external devices or memories such as external drives, databases, or enterprise storage systems containing data and/or instructions accessed or used by the computer or series of computers. A computerized system further includes any communication links between the computer(s) and external devices or memories and any communication links between computers.

As used herein, a “source” of a request refers to any application or user capable of accessing a stored data object.

As used herein, a “locking strategy” refers to any group of one or more parameters defining the operation of a lock on a stored data object. The parameters of a locking strategy may include, for example, a lock mode as described above, a “lock scope,” and/or a “lock duration.” Lock scope, or granularity, identifies which unit or units of stored data are being locked. In a database, for example, the lock scope may be an entire row, table, page, database, a unique entry in the database, or any portion or combination thereof. Lock duration, or life-span, is the amount of time that a particular lock is valid for the unit of data. The lock duration may be a fixed period of time, or the lock duration may be indefinite where the lock is released using a command or when the use of a data object, or operation on a data object, has completed. Examples of operations that might be performed on a data object include read, write, delete, or move operations. An operation is also referred to herein as a “transaction.”

As used herein, a “lock object” refers to a stored data object that has been physically locked, where a “physical lock” is a lock that has been set and is effective on a stored data object. The lock may be set by any hardware, software, or firmware means having the capability of controlling access to the data object.

As used herein, a “locking layer” refers to an intermediary application or layer provided between stored data objects and sources having access to those objects. The locking layer may perform various functions, such as mediating requests by sources to use stored data objects and communicating information regarding the stored data objects and their locks to the sources. The locking layer may be implemented in software running on any processor that communicates directly or indirectly with both the applications and data objects. Alternatively, the locking layer may be implemented as a stand-alone device or system of devices, either computerized or software-implemented, to perform the methods and features disclosed herein.

In one embodiment, the locking layer functionality may exist or be provided to applications as an application programming interface (API). The locking layer API may include, for example, function calls or commands, which an application uses to request the use of a stored data object. The locking layer recognizes commands sent via the API and responds according to the principles and methods disclosed herein. The principles and methods disclosed herein may be implemented as a new API or may be implemented as additional features for an existing API, such as WebDAV (Web-based Distributed Authoring and Versioning).

In accordance with one embodiment, the locking layer accesses or otherwise uses “locking configuration rules” to determine the locking strategy for a request. The locking configuration rules may be stored within the computer system in any location that the locking layer can access, including in the locking layer itself. Locking configuration rules may comprise any set of instructions, tables, or databases of information referenced by the locking layer that indicate a locking strategy for a request to use a data object. The locking configuration rules may indicate a locking strategy based on any combination of the following parameters: the source of the request, the use of the data object requested, the role of the user making the request, or the particular data object for which the use is requested. In addition, the locking configuration rules may indicate whether a user or application has the ability to specify any or all aspects of the locking strategy.

For purposes of illustration, assume a user or application requires the use of data objects for some length of time and cannot tolerate changes to the data objects. In such cases, the user or application may want to obtain an exclusive lock on the data objects. The user may want an exclusive lock even though the actual use he/she is implementing would not normally require an exclusive lock according to the configuration rules. An example is using an employee database for planning purposes. A manager may require the use of a number of employee records in the database, although he/she does not necessarily want to modify them. This use would ordinarily be set-up in the configuration rules to require a shared or optimistic lock. However, the manager may not be able to create an effective plan if the employee records are being modified during his/her use, and according to the principles and methods disclosed herein, may be allowed to demand an exclusive lock. The manager, in this way, may effectively override what the locking layer would normally determine as the locking scope for his/her request based on his/her usage of the database records.

Additionally, consistent with an aspect of the present invention, the locking configuration rules may indicate a default locking strategy corresponding to any of the above-mentioned parameters or combinations of those parameters. For example, the locking configuration rules may indicate a default locking strategy of obtaining an optimistic lock for any request for any use of a particular data object.

At any time, a system administrator may be permitted to modify or customize the locking configuration rules. This modification may include selecting, creating, or changing the locking configuration rules that will be referenced by the locking layer for requests to use data objects from an application. Additionally, a default set of locking configuration rules could be selected or implemented by the locking layer when no configuration rules have been established for an application. These default rules may later be modified by a system administrator as noted above.

As used herein, a “data management server” is any hardware and/or application that physically controls access to stored data objects. A data management server may be, for example, a lock server or an enqueue server. The data management server typically administers physical locks on the data objects and can interact with a “lock table.”

A “lock table,” as used herein, is any database or group of databases containing information regarding which data objects are locked and which applications or transactions correspond to each lock. By referencing a lock table, a data management server can check for conflicts between existing locks and the present lock request sent by the locking layer. The lock table may be stored on an application server, on the data management server, or in any other place where it may be accessed by the entity providing the physical locks.

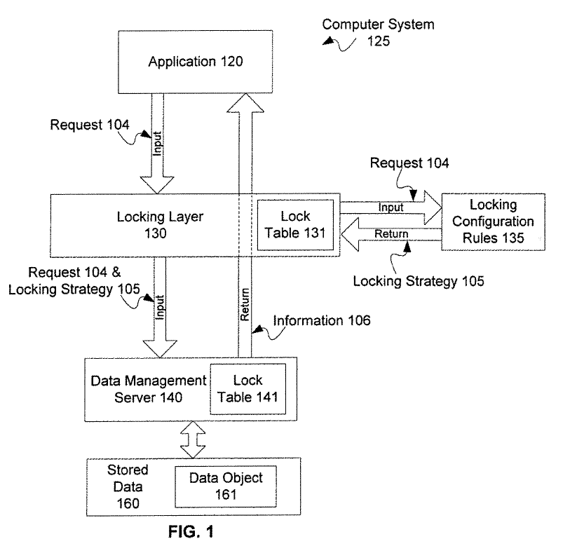

Another potential function of the data management server is to resolve which data objects are implicated by a particular request. In one embodiment of the present invention, such as in FIG. 1, the locking layer communicates with a data management server. In alternative embodiments, any or all of the functions of the data management server are implemented in the locking layer. In yet another embodiment, the locking layer is a module within a data management server.

The principles, methods, and systems disclosed herein can provide numerous advantages. One advantage is that the locking configuration rules are not hard-coded in the application and are centralized in the locking layer, so that administrators do not need to modify application source code to influence the locking. For example, an administrator can change the locking strategy associated with a particular data object without making modifications to the source code of all applications that have the potential to use that data object. As another example, administrators can more easily change the locking configuration rules when they are no longer suitable for the needs of the users or to better optimize resources.

To facilitate upgrades, updates, maintenance, and modification of the locking layer, an interface, such as a graphical user interface (GUI) or series of GUIs, may be provided to a system administrator or other authorized user. Such an interface may allow the administrator to make changes to the locking configuration rules, add locking configuration rules, and/or delete locking configuration rules. The interface may require a password or have alternative access controls to ensure that the locking configuration rules are not changed by unauthorized individuals.

In one embodiment, a system administrator is provided the option to dynamically set or adjust the locking configuration rules. For example, a set of locking configuration rules may be configured to be active during particular time intervals consistent with system usage or access patterns to data objects. This may be necessary to set particular combinations of locking configurations for the day versus the night, or seasonally depending on business activities or other factors impacting access to data objects in the system. For this purpose, a GUI may include control buttons and/or fields that permit a system administrator to configure each locking configuration rule as “active” or “inactive” and/or to set time intervals when a rule is considered active versus inactive.

Another exemplary advantage results from embodiments implemented using an API configuration. Since requests are made to the locking layer via the API, the locking layer can be easily be changed, upgraded, or replaced without affecting the format of application requests.

Yet another exemplary advantage of embodiments of the invention is that the locking strategy for an application no longer needs to be determined when the application is designed, potentially reducing development time and complexity, and ensuring consistency in locking strategies across applications. Further, the principles and methods disclosed herein may reduce and more effectively manage conflicts from requests attempting to acquire restrictive locks on the same data objects.

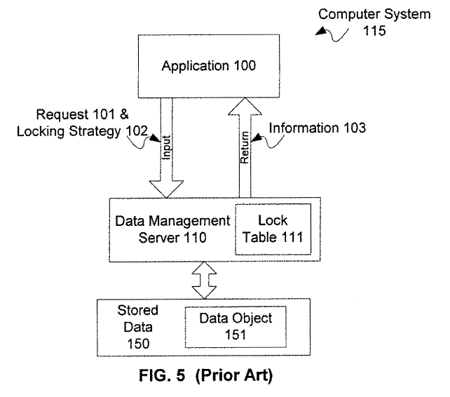

FIG. 5 illustrates an exemplary, conventional computer system 115. In this system, an application 100 initiates a request 101 to use a specified stored data object 151, which is found in stored data 150 and accessed through a data management server 110. The application requests a particular locking strategy 102 including a lock mode when making request 101. For the purpose of this example, the lock mode is “exclusive” for request 101, so that if a physical lock is established for request 101 by data management server 110, only request 101 will have access to stored data object 151.

Upon receipt of the request 101 and the locking strategy 102, the data management server 110 references lock table 111 to check for any previously requested locks on stored data object 151. A conflict may exist, for example, if an exclusive lock has already been set on the stored data object 151, since a data object may only be exclusively locked by one source. A conflict may also exist, for example, if locking strategy 102 included a lock mode of “optimistic” and an exclusive lock had already been set on stored data object 151.

If there is no conflict, the data management server 110 returns information 103 to the application 100. Information 103 includes an indication that the lock was successful and the lock table 111 is updated to reflect that an exclusive lock has been set on data object 151 associated with 101 and having locking strategy 102. Information 103 also includes a lock object, the data object 151. Had there been a conflict, information 103 would include an indication that the lock was not successful and information 103 would not include the lock object.

FIG. 1 illustrates an exemplary computer system 125, consistent with an embodiment of the present invention. In system 125, an application 120 initiates a request 104 to use a specified stored data object 161, which is found in stored data 160 and accessed through a data management server 140. In this system, however, the request is mediated by a locking layer 130, and the application does not request a particular locking strategy when making request 104. The locking strategy 105 is instead determined by the locking layer 130 by accessing and/or referencing locking configuration rules 135 to determine the locking strategy 105. In certain embodiments of the present invention, the locking configuration rules 135 may be stored in memory that is included in locking layer 130 or may be in stored memory external to the locking layer 130.

Request 104 includes an identification of the application making the request. The request 104 may also include information about the use of the data object, such as read, write, or move, and an identification of a data object, which may be identified using a locking argument. Request 104 does not need to include any parameter of the locking strategy including the lock mode since locking layer 130 can determine the locking strategy according to the methods and principles disclosed herein. Locking configuration rules 135 may indicate a locking strategy 105 based on any combination of elements included in request 104. For example, the locking configuration rules 135 may indicate that for a request from the identified application 120 to read any stored data object in stored data 160, the locking strategy 105 should include an exclusive lock mode. As another example, the locking configuration rules 135 may indicate that for a request from the identified application 120 to read stored data object 161, locking strategy 105 should include an optimistic lock mode. For yet another example, the locking configuration rules 135 may indicate a locking strategy 105 for any request from the identified application 120 for any use of any stored data object.

The locking layer 130 may access and/or reference a lock table 131 to check for conflicts with previously set locks on data object 161. A conflict may exist, for example, if locking strategy 105, as determined by the locking configuration rules 135, includes an exclusive locking mode and an exclusive lock has already been set corresponding to another request for the use of stored data object 161. Alternatively, or additionally, the conflicts checking function may be performed by the data management server 140.

When there is a conflict, locking layer 130 may refuse the requested access to data object 161 and may send a message to application 120 that the request has been refused. Alternatively, locking layer 130 may queue the request until the conflict is resolved by the release or change in the locking strategy of previously set locks, or locking layer 130 may indicate to the data management server 140 that the request 104 should be queued until the conflict is resolved.

If there is no conflict, the locking layer 130 sends the request 104 and locking strategy 105 to data management server 140. If no conflict exists, or if conflicts checks are only performed by locking layer 130, data management server 140 returns information 106 to the application 120. In alternative embodiments, a second conflicts check may be performed by data management server 140 using lock table 141, which is updated with request 104 and locking strategy 105 to reflect the physical lock set on data object 161.

Information 106 may include an indication that the lock was successful, as well as the lock object, which is stored data object 161. In addition, information 106 may notify the application 120 of the locking strategy 105, which was established by locking layer 130. When information 106 is returned, lock table 141 may be updated to reflect whether a lock was set on data object 161. Alternatively, the lock table 111 is updated by locking layer 130 before sending request 104 and locking strategy 105 to the data management 140. It may be preferable to update lock table 131 as early as possible, such as before sending request 104 and locking strategy 105 to data management server 140, so that subsequent requests to use data object 161 can be checked for conflicts as soon as possible.

Alternative embodiments consistent with the principles of the present invention may also be implemented in a web-based environment, for example, as features of the WebDAV API. In such embodiments, application 120 may be a web-based application or browser and data management server 140 may be a web server or any computer providing content accessible via a web-based protocol including http. In such embodiments, the request 104 would include an identification of the stored data object in the form of a web address such as a URL.

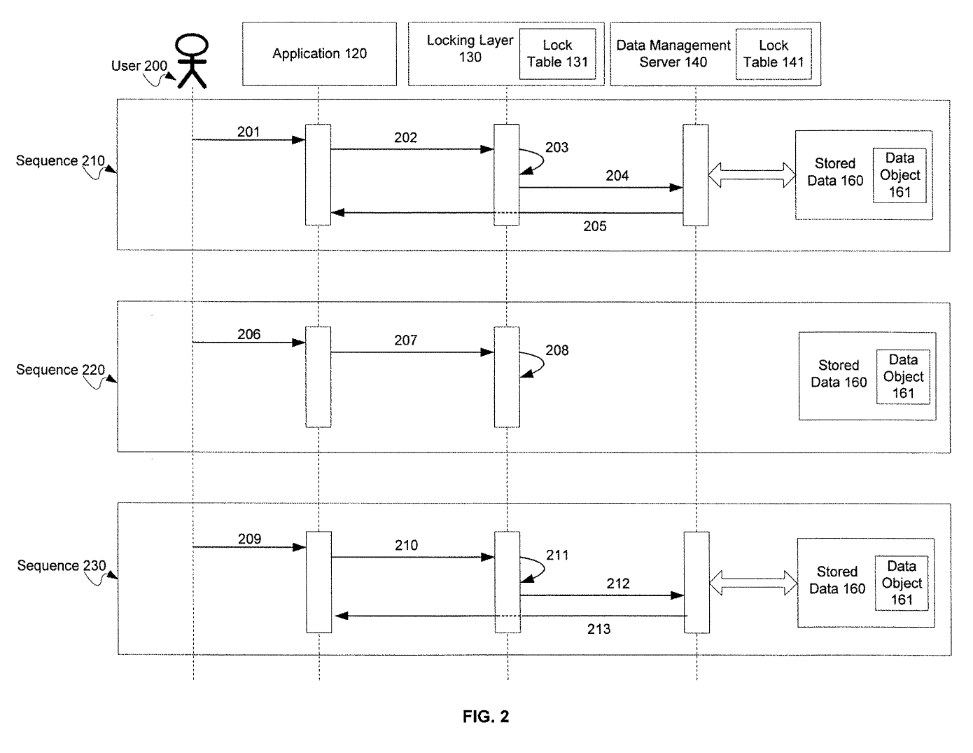

FIG. 2 illustrates three exemplary sequences of events that may occur in a computer system, such as the exemplary embodiment of FIG. 1. Sequence 210 is an exemplary sequence illustrating the initial request from an application sent to a locking layer, or an initialization sequence. In this sequence, user 200 performs some action at stage 201 on application 120. If application 120 is, for example, a word processing application, action 201 may be user 200 “saving” new data to an existing file that is stored in stored data 160 as data object 161. The request to write the new data is sent to locking layer 130 at stage 202. Locking layer 130 checks the configuration rules at stage 203 to establish the locking strategy for the write request, and sends the locking strategy and write request to the data management server 140 at stage 204, which then creates the physical lock 205 after performing a conflicts check using lock table 141. When there are no conflicts, the lock object and any information regarding the lock and associated locking strategy is returned to application 120 at stage 205.

Sequence 220 is an exemplary sequence illustrating a subsequent action by user 200 of application 120. In one embodiment, the locking layer 130 would be invoked, as shown in stage 207, regardless of whether any new data objects in stored data 160 require locks or whether any change in locking strategy is required (i.e. locking layer 130 is invoked for all requests). For example, if the previous request by user 200 had resulted in a read lock being granted at stage 205 to user 200 for reading stored data object 161, the locking layer would be invoked again, even if at stage 206, the user 200 requests to read the same stored data object 161. This subsequent invocation of the locking layer 130 is necessary to perform a “consistency check” at stage 208 on data object 161.

A consistency check may include a process that checks whether data is still valid. For example, if another application or user had requested to write to data object 161 since the last read request at stage 201 by user 200, the locking layer 130 would determine, during the consistency check, whether the previously granted lock 205 to user 200 is still valid. If a “dirty read,” or a reading of data that is no longer valid, was performed at stage 206 by user 200. Locking layer 130 may send a “notification batch” to each of the applications using data object 161, notifying all applications using data object 161 that the data they have associated with data object 161 may not be valid. When this notification is received, the applications may initiate their own recovery mechanisms. Such recovery mechanisms may include a re-read of the requested data and termination of the application in certain circumstances.

Sequence 230 is an exemplary sequence illustrating a subsequent action by user 200 of application 120 that requires a change in the locking strategy that had been established at stage 208. For the purpose of this example, the locking strategy for stored data object 161, as determined at stage 208, includes an “optimistic” locking mode.

At stage 209, the user 200 performs an action on application 120, which generates a request to write to stored data object 161 that is sent to locking layer 130 at stage 210. At stage 211, locking layer 130 determines, by checking locking table 111, that a previous lock on stored data object 161 is still effective for user 200 of application 120. The locking layer may then change the locking strategy of the previous optimistic lock on stored data object 161 to have a locking mode of exclusive, as determined in stage 211. The request is then forwarded to data management server 140 along with the associated new locking strategy.

A change in locking strategy may be triggered by a new request received in the locking layer by the same user or application and the same data object. As shown above, a read request followed by a write request, or commit statement in a database application, may require that an optimistic lock be changed to an exclusive lock for the same user or application. Similarly, a change in locking strategy may be necessary for locks set by other applications using the same stored data object 161. Locking layer 130 may notify applications or users having optimistic locks on stored data object 161 be notified that their locks are no longer valid, or that new data is available.

Since the locking strategy may change during runtime of an application and is not hard coded into the application, access to stored data objects can be less restrictive and more efficient. For example, more restrictive locks, such as exclusive locks, can be obtained as late as possible rather than at the start of an application, but can still be obtained when they are necessary for a particular use.

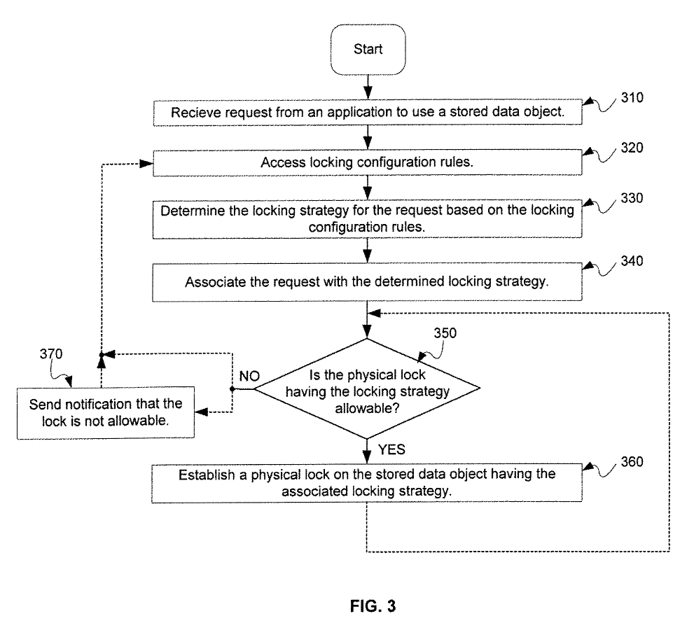

FIG. 3 illustrates an exemplary method, consistent with an embodiment of the present invention. In stage 310, the locking layer receives a request from an application to use a stored data object, and in stage 320, the locking layer accesses or uses locking configuration rules. At stage 330, the locking layer determines the locking strategy for the request based on the locking configuration rules. The determined locking strategy is then associated with the request in stage 340. In the exemplary method of FIG. 3, the locking layer then checks if a physical lock having the associated locking strategy is allowable at stage 350. When the lock is allowable, a physical lock on the stored data object having the associated locking strategy is established at stage 360. According to the exemplary method, the locking layer may then optionally continue to check that the physical lock is allowable. This checking may be triggered by another request to use the same stored data object by the same application or by a different application or may be performed periodically. When the lock is not allowable in stage 350, the locking layer may optionally send notification to the application that the lock is not allowable at stage 370. In addition, when the lock is not allowable, the locking layer may access the locking configuration rules again at stage 320 to determine a different locking strategy.

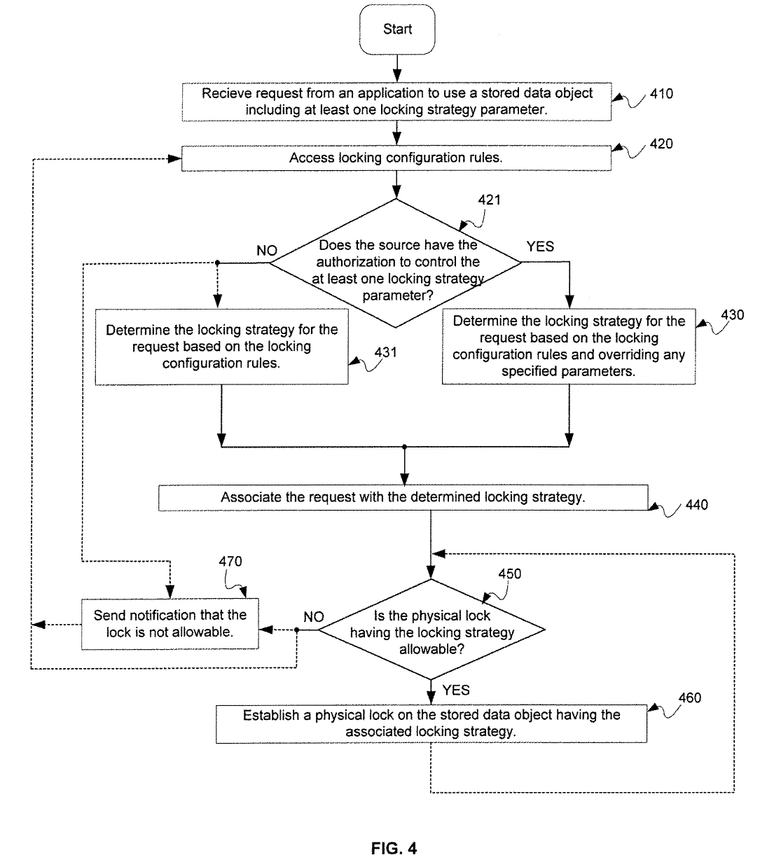

FIG. 4 illustrates another exemplary method, consistent with an embodiment of the present invention. In stage 410, a request from an application to use a stored data object is received by the locking layer. This request may include at least one locking strategy parameter specified by the user, and in stage 420, the locking layer accesses or uses locking configuration rules. At stage 421, the locking layer checks the locking configuration rules to determine if the user has the authorization to control the at least on parameter specified. If the user does have authorization, at stage 430, the locking layer determines the locking strategy for the request based on the locking configuration rules, however, any parameters specified by the user are overridden by the parameter specified by the user. The determined locking strategy, including the user specified parameter, is then associated with the request in stage 440. In alternative embodiments, the locking layer may omit stage 421 and always assume the user has authorization.

If the user does not have authorization to control the at least one locking strategy parameter, as determined in stage 421, the locking layer may optionally determine the locking strategy based on the locking configuration rules and ignore the specified parameter at stage 431. Alternatively, in stage 470, the locking layer optionally sends notification to the application that the lock was not allowable.

Where a physical lock is to be established, at stage 440, the locking layer associates the request with the determined locking strategy, which either includes the user's specified parameter (stage 430) or ignores it (stage 431). In the exemplary method of FIG. 4, locking layer then checks if a physical lock having the associated locking strategy is allowable at stage 450. When the lock is allowable, a physical lock on the stored data object having the associated locking strategy is established at stage 460. The locking layer may then optionally continue to check that the physical lock is allowable. This checking may be triggered by another request to use the same stored data object or may be performed periodically. When the lock is not allowable, the locking layer may, at stage 470, optionally send notification to the application that the lock is not allowable. In addition, when the lock is not allowable, the locking layer may access the locking configuration rules again at stage 420 to determine a different locking strategy.

Other embodiments of the invention will be apparent to those skilled in the art from consideration of the specification and practice of the exemplary embodiments of the invention disclosed herein. It is intended that the specification and examples be considered as exemplary only, with a true scope and spirit of the invention being indicated by the following claims.

What is claimed is:

1. A method for dynamically selecting a locking strategy for a request by a source to use a stored data object in a computerized system, the method comprising:
receiving, by a locking layer, a request from the source to use a stored data object;
determining, with the locking layer, the locking strategy for the request based on a set of locking configuration rules, the set of locking configuration rules being modifiable by a system administrator; and
associating the request with the determined locking strategy.

2. The method of claim 1, wherein the source is one of an application or a user.

3. The method of claim 1, wherein the locking strategy comprises a lock mode.

4. The method of claim 3, wherein the lock mode comprises one of exclusive, optimistic, and shared.

5. The method of claim 3, wherein the locking strategy further comprises at least one of: a lock scope and a lock duration.

6. The method of claim 3, wherein the method is performed when use of the stored data object changes.

7. The method of claim 6, wherein the method is performed during runtime of the application.

8. The method of claim 1, wherein the request comprises the identity of the stored data object and the identity of the source.

9. The method of claim 8, wherein the set of locking configuration rules indicates the locking strategy based on the identity of the source.

10. The method of claim 9, wherein the request further comprises information about the use of the stored data object, and wherein the set of locking configuration rules further indicates the locking strategy based on at least one of the identity of the stored data object and the information about the use of the stored data object.

11. The method of claim 3, further comprising:
sending the request and associated locking strategy to a data management server, the data management server determining if a physical lock on the stored data object having the associated locking strategy is allowable, and when the physical lock is allowable, establishing the physical lock on the stored data object, the physical lock having the associated locking strategy.

12. The method of claim 3, wherein receiving the request further comprises receiving a fixed locking strategy associated with the request, the fixed locking strategy being set by a user of the application, and wherein the method further comprises associating the request with the fixed locking strategy when the set of configuration rules indicate that the user is allowed to set the locking strategy.

13. The method of claim 3, wherein the set of locking configuration rules identifies a default locking strategy having a default lock mode.

14. The method of claim 12, wherein the default lock mode is optimistic.

15. The method of claim 1, wherein the application sends the request to the locking layer using an application programming interface (API).

16. The method of claim 1, wherein the stored data object is identified by a URL.

17. The method of claim 1, further comprising:
changing the determined locking strategy to a new locking strategy; and
associating the new locking strategy with the request.

18. The method of claim 17, wherein the changing is initiated by the user.

19. The method of claim 18, wherein the changing is initiated by a conflict with a second locking strategy selected according to claim 1.

20. The method of claim 1, further comprising:
checking for a previously set physical lock associated with a previous request on the stored data object, the previously set physical lock having a previously set locking strategy;
comparing the previously set locking strategy with the locking strategy associated with the request; and
notifying the application making the request and the application making the previous request when the comparison shows a conflict.

21. The method of claim 20, further comprising:
changing the locking strategy associated with the previous request.

22. A computer system comprising:
a memory comprising program instructions;
input means for receiving and entering data;
output means for sending and presenting data;
storage means for storing data objects;
means for locking the data objects;
at least one processor responsive to the program instructions for performing a method for dynamically selecting a locking strategy for a request by an application to use a stored data object, the method comprising:
receiving, by a locking layer, a request from the application to use a stored data object;
determining, with the locking layer, the locking strategy for the request based on a set of locking configuration rules, the set of locking configuration rules being modifiable by a system administrator; and
associating the request with the determined locking strategy.

23. The computer system of claim 22 further comprising a data management server, wherein the method further comprises sending the request and associated locking strategy to the data management server, the data management server determining if a physical lock on the stored data object having the associated locking strategy is allowable, and when the physical lock is allowable, establishing the physical lock on the stored data object, the physical lock having the associated locking strategy.

24. The computer system of claim 22, wherein the set of locking configuration rules identifies a default locking strategy having a default lock mode, wherein the default lock mode is optimistic.

25. The computer system of claim 22, wherein the method further comprises changing the determined locking strategy to a new locking strategy; and associating the new locking strategy with the request.

26. A computer readable medium comprising program instructions, which when executed by a processor perform a method, the method comprising:
receiving, by a locking layer, a request from an application to use a stored data object;
accessing a set of locking configuration rules in response to the request;
determining, with the locking layer, the locking strategy for the request based on a set of locking configuration rules, the set of locking configuration rules being modifiable by a system administrator; and
associating the request with the determined locking strategy.

27. The computer readable medium of claim 26, wherein the method further comprises sending the request and associated locking strategy to a data management server, the data management server determining if a physical lock on the stored data object having the associated locking strategy is allowable, and when the physical lock is allowable, establishing the physical lock on the stored data object, the physical lock having the associated locking strategy.

28. The computer readable medium of claim 26, wherein the method further comprises changing the determined locking strategy to a new locking strategy; and associating the new locking strategy with the request.
